(19) United States
(12) Patent Application Publication
(10) Pub. No.: US 2013/0112445 A1
(43) Pub. Date: May 9, 2013

(54) Tool caddy integrated within or attachable to a housing of a portable power tool for magnetic or mechanical support for screws, screwbits, and drillbits

(71) Applicant: DEAN DRAKO, Los Altos, CA (US)

(72) Inventor: DEAN DRAKO, Los Altos, CA (US)

(21) Appl. No.: 13/288,221

(22) Filed: Nov. 3, 2011

(51) Int. Cl. B25F 5/00; H01M 2/02

(52) U.S. Cl. 173/46; 429/8

(57) ABSTRACT

An enhanced housing for portable power tools provides a magazine for accessories and consumables which conveniently holds screws, rapidly interchangeable screw bits, drill bits, and other light tools substantially on the power tool itself. A magnetic field generating module attached to, attachable, or integrated with a battery charger, a removable battery, or a handholdable powered drill or driver whereby one hand may support the power tool, various screws, screw bits, and drill bits while the other hand places or replaces screws, the screw bits, or drill bits without requiring a reachable shelf, table, garment, or pocket.

### TECHNICAL FIELD OF THE INVENTION

The present invention pertains to an electrical hand tool. The hand tool is for use as a screwdriver and/or drill, the housing of which consists of a drive component, on one side of which a motor and a gear box are mounted in a drive housing. A magnetic or mechanical storage holder provided in or attached to a drive housing or a battery housing for lightweight handholdable powered tool accessories such as interchangeable bits and consumables such as screws.

### BACKGROUND ART

Many patents have been granted that fail to address an issue of portability and convenience for exchangeable tools:

Pat. No. Title
U.S. Pat. No. 7,114,592 Ladder with magnetic tool holder plate
U.S. Pat. No. 4,451,810 Magnetic tool holder

Portable power tools such as drills and drivers are in common use by maintenance and construction workers. These portable tools have greatly increased the efficiency and workflow of this labor area. The same power tool can easily be adapted to drill and to screw rather than switching between two different tools.

Many of these tools normally have a chuck or other mechanism for holding different types of bits, blades, or cutters. The bits may be screw bits, drywall bits, drill bits, specialized drill bits, or many different kinds of generic and trademarked screw bits (Philips™, torx™, blade, flat, etc . . . ).

It is common to buy sets of drill bits but use only a few frequently and to replace broken or dull ones individually:
DeWalt 29-Piece Cobalt Drill Bit Set
DeWalt 16 Piece Pilot Point Drill Bit Set,
Maxtech 32-Piece Precision Bit Set,
Makita 62-Piece Impact Drill-Driver Bit Set, and
Bosch 18-Piece Titanium Twist Drill Bit assortment with plastic case. It can be appreciated that few people can open a case of drill bits and remove one while holding a drill in the other hand.

It is common to buy a kit of screw bits as listed below:
DeWalt 37 Piece Screwdriving Set with Tough Case;
Black and Decker Double Ended Screwdriving Bit Set 10 piece;
Milwaukee Shockwave 29-Piece Driver Bit Set. It is uncommon for any job to require more than two bits out of any of these sets.

When working, it is common to have to change bits regularly on the drill or driver. Hence the invention of so called quick change bit systems which use a magnet to hold the bit in a holder/extension that is first installed in the drill or driver.

The problem is that when you are working away from your workshop and changing bits in place there is no convenient surface to set the extra bits when you change. If you set them on the ground you often lose them. If you hold them with your hand you are unable to work effectively. If you hold them in a pocket they are out of sight. Since the drill/driver occupies one hand what is needed is a convenient way to store and access other bits using only the unoccupied hand. This same issue applies to holding the screws that you may need to install or remove during the work. Do it yourselfers find it presumptuous to buy and wear tool aprons as professionals have. Moreover, reaching into pockets of clothing or tool aprons and refocusing your vision to select the next tool or screw is disorienting while standing on ladders or scaffolds.

A conventional drill bit screw bit magazine is illustrated in

FIG. 5 which also suggests the awkward time-consuming manual steps which limit productivity. Step 1 is opening the case which must require both hands of the operator. Step 2 is selecting the specific tool in this case a drill which is typically between other small items and difficult to get a grip on. Step 3 is removing and installing the drill bit or screw bit into the chuck (not shown) of the power tool. This also requires both hands so the magazine is likely to be closed step 4 and placed on a surface or in a pocket. Steps 1-4 must be reversed to switch from a drill bit to a screw bit which is desireable to do before changing your location to the next drilling location.

What is needed is a way to stage only the tools, drillbits, screwbits, and screws you anticipate needing for a particular work flow in a convenient place with only one hand.

### SUMMARY OF THE INVENTION

An improved housing for a portable power tool such as a motor, valve, battery or a drive includes an accessory holder. magnetic field generation assembly. The assembly temporarily fastens drill bits, screw bits, screws, saw blades or other interchangeable accessories or consumables to the portable power tool itself with sufficient force to suspend the interchangeable accessories or consumables against gravity and accelerations from transporting and operating the drive. An apparatus attached to or attachable to a power drill or driver commonly used in construction and maintenance is disclosed to hold screws, screwbits, and drill bits magnetically.

A magnetic tool holder is attached to a handholdable powered tool. An operator may more easily change from one size drill bit to another, from a drill bit to a screw bit, and then access and install the screws with one hand while the powered tool occupies the other one hand. The magnetic tool holder supports any selection of drill bits, screw bits, and screws in a location convenient for transportation and operation. It may be integrated with the drill or its removable power storage unit(s) or aftermarket replacement power storage units.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a partially exploded perspective view of a battery housing, a power drill housing, and a power tool in accordance with the present invention;

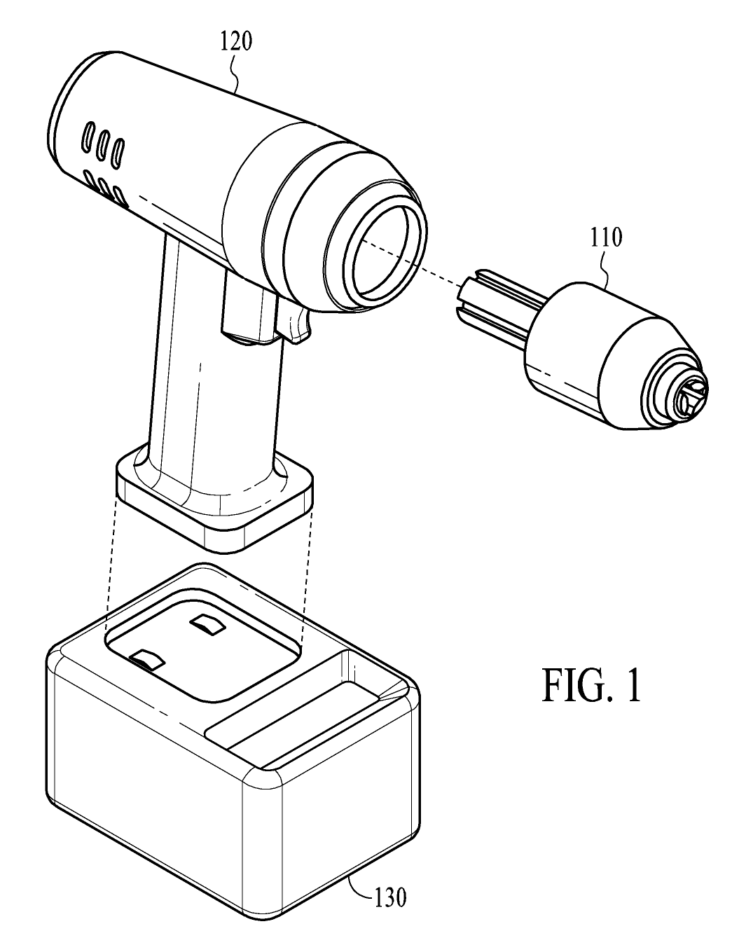

FIG. 2 is a drawing of an embodiment of the invention comprising or attached to a removable power storage unit of a powered drill or driver;

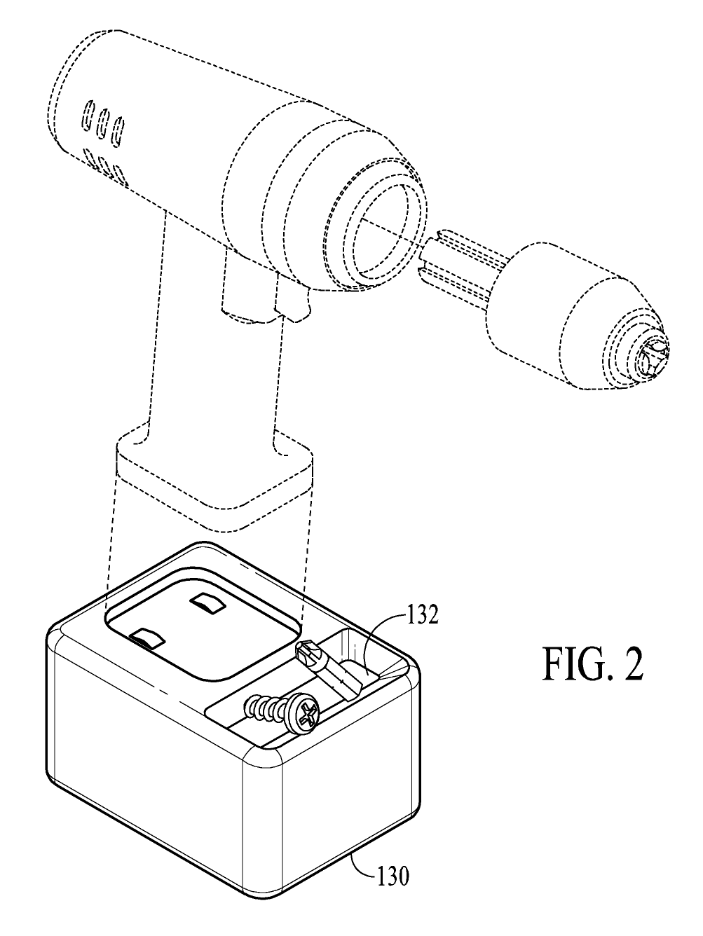

FIG. 3 is a drawing of an embodiment of the invention comprising a drill housing;

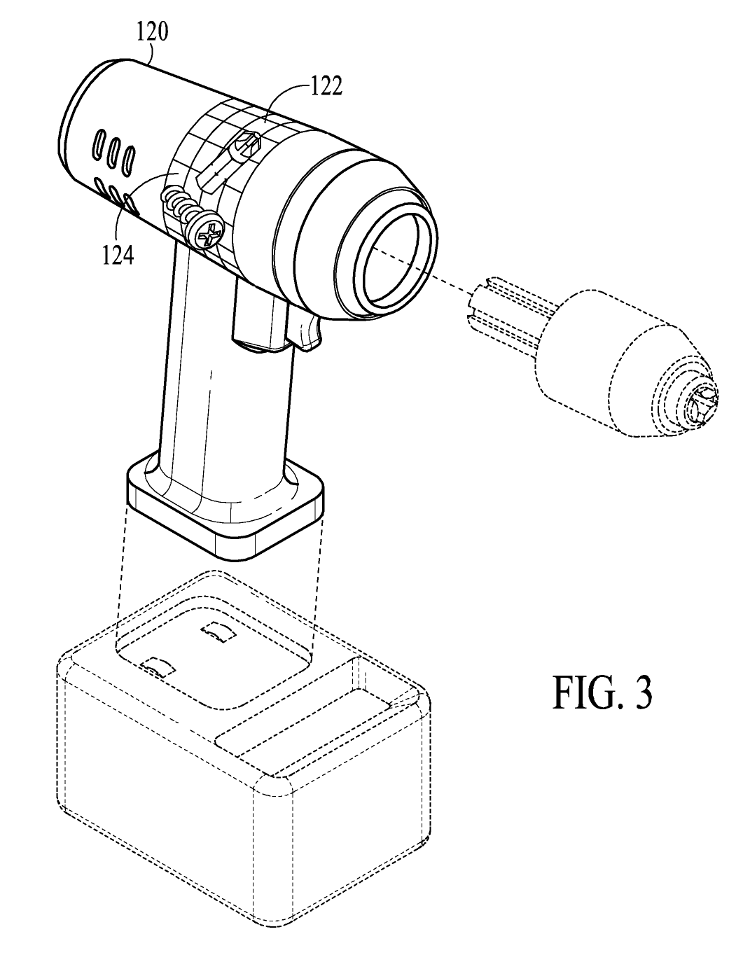

FIG. 4 is a drawing of an embodiment of the invention coupled to a drill housing; and

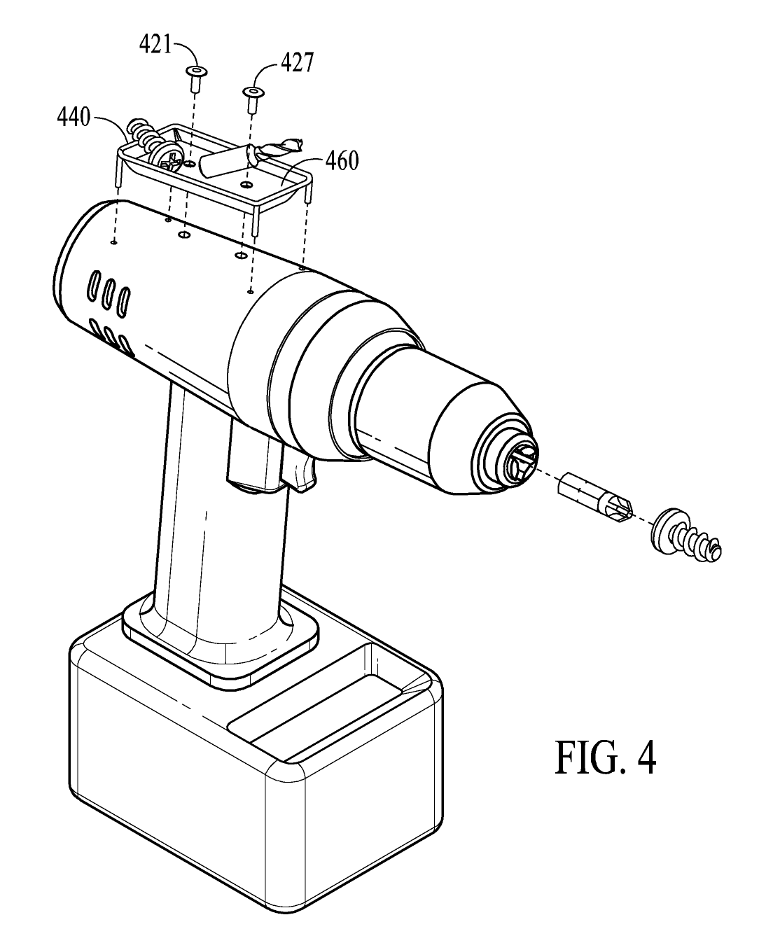

FIGS. 5 is an exemplary conventional drill and bit magazine.

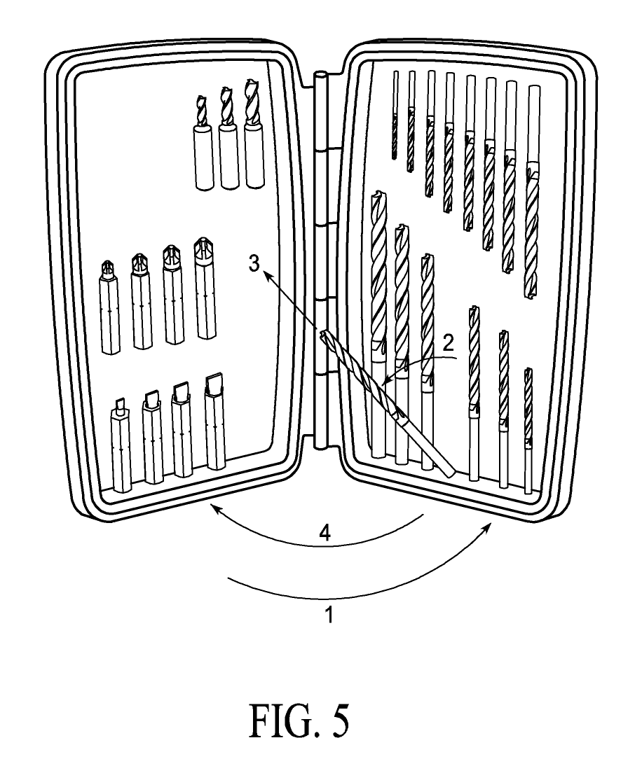

### DETAILED DISCLOSURE OF EMBODIMENTS

A portable power tool is disclosed with a magnetically attractable section or device used to hold accessories where the magnetic area is either built into the housing or means for attachment. Means for attachment include glue, rivets, screws, mechanical friction, welds, solder, threads, hook and eye, a bayonette, springs, wire, and the equivalents. In an embodiment the power tool is driven by vacuum or compressed air. In an embodiment the power tool is driven by an electrical power cord. In a preferred embodiment the power tool is battery powered. In an embodiment the power tool is a drill or driver. In an embodiment, the tool is a saw or chisel. In an embodiment, the tool is a hammer.

There can be one or more areas on the power tool to attach consumables or accessories. In embodiments the one or more areas of attachment are on the top, on the rear, on the base of a handle, on one or both sides, on the bottom, below the chuck, or on a rail attached to the housing. A first area could hold screws, a second area could hold screw bits, a third area could hold drill bits, and a fourth area could hold a stud finder or a jig to ensure perpendicularity.

A magnetic holder of bits and screws and other hardware has a fastener for attachment to a convenient location of a conventional powered drill or driver. Such locations may be to the base, the top, the sides, or to the handle. The holder may be attached to or form part of the removable power unit which contains a rechargeable battery. The magnetic field which holds the bits and screws allows the operator to easily see, select, and remove the desired accessory or tool. It holds them in a convenient location and does not require refocusing vision or attention. The holder may be of any shape. A pan, a circular plate, a disk, a hexagonal collar, a dish, or a grid will work. It helps to avoid loss of bits that fall to the bottom of a pocket or toolchest.

In an embodiment the magnetic holder is shaped in a way to hold the bits in a structured fashion. In an embodiment a holder has slots to separate a plurality of bits. In an embodiment, the holder uses a magnetic field on magnetic materials and a mechanical fit to hold non-magnetic materials. In an embodiment a holder has wells to hold a plurality of drill bits. In an embodiment a holder is has the shape of a honeycomb. In an embodiment each drill bit slides into a three, four, five, or six sided chamber or a cylindrical chamber.

One embodiment of the invention is a product which can be added to a conventional power tool in common use. This would comprise a fastener suitable for coupling to a surface of a power drill or driver coupled to a magnetic field generating module, wherein said fastener is glue, hook and eye, screws, rivets, welds, or an aperture molded into the case of the power drill or driver.

In an embodiment, the magnetic field generating module is further coupled to a magnetic field conductive tool magazine whereby screws, screw bits, and drill bits are attached by a magnetic force to the power drill or driver greater than the force of gravity yet removable by the operator and wherein the tool magazine is one of a pan, a plate, a circle, a disk, a hexagonal prism, a ribbed grating, or a plurality of concave recesses.

Another embodiment of the invention is an integrated power tool with added convenience and functionality which reduces the number of hands or steps needed to perform drilling, and screwing work. Thus, a magnetically attractive battery powered handholdable drill, driver, or powered screwdriver apparatus is disclosed comprising:
a conventional battery powered drill, driver, or powered screwdriver, coupled to
a fastener, the fastener further coupled to
a magnetic field generating module, the magnetic field generating module further coupled to
a tool magazine whereby tools are held substantially attached to the handholdable apparatus by a magnetic force greater than gravitational plus accelerational forces applied to each tool.

In one embodiment the magnetic field generating module is a permanent magnet. In an other embodiment, the magnetic field generating module is an electro-magnet. A manually operable switch may be electrically coupled between the power unit and the electro-magnet.

In an embodiment, magnetic field generating module is a flywheel. As is known, fluctuating electrical fields generate magnetic fields and vice versa.

In various non-limiting exemplary embodiments, the fastener is adhesive material, glue, hook and eye, rivets, solder, a weld, screws, molded into the external case of the power storage unit, mechanical friction. But any equivalent is also claimed since integration of the magnetic field generating module and the power tool is the objective.

In various non-limiting exemplary embodiments the tool magazine is a holder, a pan, a dish, a circle, hex holders, a magnetically conductive plate, a concave tray, a ribbed grating, or a plurality of sockets. The tool magazine and the magnetic field generating module may also be integrated. An embodiment is to manufacture the tool magazine itself out of material with magnetic properties. An embodiment is to finish the surface of the magnetic field generating module to cosmetically and functionally augment the power tool. An embodiment is a shaped and painted permanent magnet which fastens (e.g. by snapping into) with a recess in the case of the power tool.

In an embodiment the magnetic field generating module is energized by a current from the battery. In an embodiment the magnetic field generating module is energized by rotational operation of the battery powered drill, driver, or power screwdriver. In this case the initialization of the magnetic field is accomplished by operating the power tool for a few seconds. If the rotational energy is stored in a flywheel, the decay of the magnetic field may extended in time.

In an other embodiment, the power tool itself may not be modified but the power storage unit which must be periodically replaced as batteries wear out may be integrated with the tool holder. Thus an after market power storage unit with added functionality may be provided to a previously owned power tool. In this embodiment, a magnetically attractive portable power storage unit for a battery powered drill, driver, or power screwdriver is disclosed comprising:
a conventional removable power storage unit for a hand-held battery powered drill or driver, coupled to
a fastener, the fastener further coupled to
a magnetic field generating module, the magnetic field generating module further coupled to
a tool magazine whereby tools are held substantially attached to the hand-held battery powered drill or driver by a magnetic force greater than gravitational force applied to each tool.

In various non-limiting exemplary embodiments the magnetically attractive portable power storage unit wherein the magnetic field generating module is
a permanent magnet,
an electro-magnet,
a super-conducting magnet or
a flywheel.

In various non-limiting exemplary embodiments and equivalents the integration of the parts is illustrated by a fastener such as adhesive material, glue, hook and eye, rivets, solder, a weld, screws, molded into the external case of the power storage unit, mechanical friction.

In non-limiting exemplary embodiments, the tool magazine is a holder, a pan, a dish, a circle, hex holders, a magnetically conductive plate, a concave tray, a ribbed grating, or a plurality of sockets. The tool magazine may simply be the magnetically conductive surface of the power storage unit immediately adjacent to the magnetic field generating unit. The tool magazine may simply be a label suggesting the position on the power storage unit where screws or bits may be held.

In an embodiment the magnetic field generating module is energized by a current from the battery within the power storage unit. It may be controlled by a switch or sensor or simply be always on when the battery has been charged.

In an embodiment, the magnetic field generating module is energized or activated by rotational operation of the battery powered drill or driver.

In many cases drill bits, screw bits, screws, and other tools are themselves magnetizable. So an area of magnetic material such as iron on the power tool will attract magnetized objects. Another embodiment of the invention is a tool magnetizing battery charging apparatus comprising:
a conventional battery charging apparatus for to charge one or more power storage units for a battery powered drill or driver, and
an electrically powered magnetic field generation module, and a fixture to hold drill bits, screw bits, or screws,
whereby the drill bits, screw bits, or screws may be magnetically polarized.

One aspect of the invention is a magnetically attractive hand tool, comprising
a drive housing component defining a drive compartment, said drive housing component including a front end with a chuck element connected thereto, a motor and a gear box positioned in said drive compartment and a switch positioned in said drive compartment; and
a battery housing component connected to said drive housing component,
wherein said hand tool has magnetic field strength sufficiently strong to suspend a plurality of screws, at least one screwbit, and at least one drill bit against the acceleration forces of gravity, transportation, and operation of the drive. In embodiments, the drive housing comprises a magnetic field generation element or the battery housing comprises a magnetic field generation unit.

Another aspect of the invention is a A magnetically attractive battery powered handholdable drill, driver, or powered screwdriver apparatus comprising:
a conventional battery powered drill, driver, or powered screwdriver, coupled to
a fastener, the fastener further coupled to
a magnetic field generating module, the magnetic field generating module further coupled to
a tool magazine whereby tools are held substantially attached to the handholdable apparatus by a magnetic force greater than gravitational plus accelerational forces applied to each tool,
wherein the magnetic field generating module is a magnet.

In embodiments, the magnetic field generating module is an electro-magnet, or a flywheel.

In an embodiment, the fastener is the fitting of the one element tightly into the other. In other embodiments, the fastener is adhesive material, glue, hook and eye, rivets, solder, a weld, or screws. In an embodiment, the fastener is being integrated into the external case of the power storage unit by heat or mechanical friction.

In embodiments the tool magazine is a holder, a pan, a dish, a circle, hex holders, a magnetically conductive plate, a concave tray, a ribbed grating, or a plurality of sockets.

In embodiments, the magnetic field generating module is energized by a current from the battery, or by rotational operation of the battery powered drill, driver, or power screwdriver.

In an embodiment, the invention is a magnetically attractive portable power storage housing for a battery powered drill, driver, or power screwdriver comprising:
a power storage unit for a hand-held battery powered drill or driver, coupled to
a fastener, the fastener further coupled to
a magnetic field generating module, the magnetic field generating module further coupled to
a tool magazine whereby tools are held substantially attached to the hand-held battery powered drill or driver by a magnetic force greater than gravitational force applied to each tool.

A fastener is adhesive material, glue, hook and eye, rivets, solder, a weld, screws, molded into the external case of the power storage unit, mechanical friction.

A tool magazine is a holder, a pan, a dish, a circle, hex holders, a magnetically conductive plate, a concave tray, a ribbed grating, or a plurality of sockets.

In an embodiment, the invention may be attached to a conventional drill by a fastener suitable for coupling to a surface of a power drill or driver housing coupled to
a magnetic field generating module, wherein said fastener is glue, hook and eye, screws, rivets, welds, or an aperture molded into the case of the power drill or driver.

The magnetic field generating module is further coupled to a magnetic field conductive tool magazine whereby screws, screw bits, and drill bits are attached by a magnetic force to the power drill or driver greater than the force of gravity yet removable by the operator and wherein the tool magazine is one of a pan, a plate, a circle, a disk, a hexagonal prism, a ribbed grating, or a plurality of concave recesses.

### CONCLUSION

The invention is distinguished from conventional magnetic tool holders by its integration with a powered drill or driver. All of the conventional holders of bits and drills are too large and difficult to carry up a ladder or to a workspace. They require a third hand to operate or open and a pocket, shelf, wristband, apron, or garment to support. There is no convenient storage for bits that are soon to but not presently in use. Mechanical holders have a practical limit in the smallest size of screw or bit they can hold.

The invention is easily distinguishable from a plastic case in which bits are packaged for retail sale. The bits are close together and held tightly which makes them hard to remove with one hand. The case is too large to carry to a workspace or up a ladder. It is difficult to replace bits into their assigned location when they will be needed again soon. Typically only 3-4 bits are needed to accomplish a task.

The invention is easily distinguishable from foam and mechanical holders. Bits are not held securely in foam. Screws cannot be placed into foam holders. Small bits may be broken if forced into a mechanical holder in the wrong alignment.

The invention is easily distinguishable from a wrist mounted holder. It is an additional step to attach the holder to your wrist. It may be uncomfortable does not allow ambidextrous use of the power tool. It requires a two handed operation to don the wrist holder before picking up the power tool. Gravity tends to rotate the wrist holder to a position where the drill bits are not easily accessible unless the drill is raised above eye level.

The invention is easily distinguished from a magnetic screw bit bandoleer. This allows bits to be easily removed and inserted from the extension which is installed in the chuck. But drill bits are not compatible with the screw bits and screws may not be added to a screw bit bandoleer.

I claim:

1. A portable power tool with a magnetically attractable section or device used to hold accessories where the magnetic area is either built into the housing or means for attachment.

2. A magnetically attractive hand tool, comprising
a drive housing component defining a drive compartment, said drive housing component including a front end with a chuck element connected thereto, a motor and a gear box positioned in said drive compartment and a switch positioned in said drive compartment; and
a battery housing component connected to said drive housing component,
wherein said hand tool has magnetic field strength sufficiently strong to suspend a plurality of screws, at least one screwbit, and at least one drill bit against the acceleration forces of gravity, transportation, and operation of the drive.

3. A magnetically attractive hand tool according to claim 2, wherein said drive housing comprises a magnetic field generation element.

4. A magnetically attractive hand tool according to claim 2, wherein said battery housing comprises a magnetic field generation unit.

5. A magnetically attractive battery powered handholdable drill, driver, or powered screwdriver apparatus comprising:
a conventional battery powered drill, driver, or powered screwdriver, coupled to
a fastener, the fastener further coupled to
a magnetic field generating module, the magnetic field generating module further coupled to
a tool magazine whereby tools are held substantially attached to the handholdable apparatus by a magnetic force greater than gravitational plus accelerational forces applied to each tool, wherein the magnetic field generating module is a magnet.

6. The magnetically attractive handholdable apparatus of claim 5 wherein the magnetic field generating module is an electro-magnet.

7. The magnetically attractive handholdable apparatus of claim 5 wherein the magnetic field generating module is a flywheel.

8. The magnetically attractive handholdable apparatus of claim 5 wherein the fastener is adhesive material, glue, hook and eye, rivets, solder, a weld, screws, molded into the external case of the power storage unit, mechanical friction.

9. The magnetically attractive handholdable apparatus of claim 5 wherein the tool magazine is a holder, a pan, a dish, a circle, hex holders, a magnetically conductive plate, a concave tray, a ribbed grating, or a plurality of sockets.

10. The magnetically attractive handholdable apparatus of claim 5 wherein the magnetic field generating module is energized by a current from the battery.

11. The magnetically attractive handholdable apparatus of claim 5 wherein the magnetic field generating module is energized by rotational operation of the battery powered drill, driver, or power screwdriver.

12. A magnetically attractive portable power storage housing for a battery powered drill, driver, or power screwdriver comprising:
a power storage unit for a hand-held battery powered drill or driver, coupled to
a fastener, the fastener further coupled to
a magnetic field generating module, the magnetic field generating module further coupled to
a tool magazine whereby tools are held substantially attached to the hand-held battery powered drill or driver by a magnetic force greater than gravitational force applied to each tool.

13. The magnetically attractive portable power storage housing of claim 12 wherein the magnetic field generating module is a permanent magnet.

14. The magnetically attractive portable power storage housing of claim 12 wherein the magnetic field generating module is an electro-magnet.

15. The magnetically attractive portable power storage housing of claim 12 wherein the magnetic field generating module is a flywheel.

16. The magnetically attractive portable power storage housing of claim 12 wherein the fastener is adhesive material, glue, hook and eye, rivets, solder, a weld, screws, molded into the external case of the power storage unit, mechanical friction.

17. The magnetically attractive portable power storage housing of claim 12 wherein the tool magazine is a holder, a pan, a dish, a circle, hex holders, a magnetically conductive plate, a concave tray, a ribbed grating, or a plurality of sockets.

18. The magnetically attractive portable power storage housing of claim 12 wherein the magnetic field generating module is energized by a current from the battery.

19. A fastener suitable for coupling to a surface of a power drill or driver housing coupled to
a magnetic field generating module, wherein said fastener is glue, hook and eye, screws, rivets, welds, or an aperture molded into the case of the power drill or driver.

20. The magnetic field generating module of claim 19 further coupled to a magnetic field conductive tool magazine whereby screws, screw bits, and drill bits are attached by a magnetic force to the power drill or driver greater than the force of gravity yet removable by the operator and wherein the tool magazine is one of a pan, a plate, a circle, a disk, a hexagonal prism, a ribbed grating, or a plurality of concave recesses.
